(19) United States
(12) Patent Application Publication
(10) Pub. No.: US 2014/0265308 A1
(43) Pub. Date: Sep. 18, 2014

(54) ADJUSTABLE BACKSHELL FOR WIRING HARNESS

(71) Applicant: Power in Operation, LLC, Wichita, KS (US)

(72) Inventors: Joseph Nathan Reilly, Wichita, KS (US); Jacqueline Marie Freed, Wichita, KS (US)

(73) Assignee: Power in Operation, LLC, Wichita, KS (US)

(21) Appl. No.: 14/275,384

(22) Filed: May 12, 2014

Related U.S. Application Data
(63) Continuation-in-part of application No. 13/569,987, filed on Aug. 8, 2012, now abandoned.

(51) Int. Cl. H01R 35/02

(52) U.S. Cl. CPC H01R 35/02
USPC 285/153.1

(57) ABSTRACT

A backshell includes a cable-receiving portion presenting a front end, a rear end, and a first longitudinal axis; a connector portion presenting a front end, a rear end, and a second longitudinal axis; and a swivel joint operably coupling the front end of the cable-receiving portion with the rear end of said connector portion and operable to permit selective relative movement between the cable-receiving portion and the connector portion such that they may assume different relative positions with the longitudinal axes thereof at correspondingly different angles.

### RELATED APPLICATION

The current patent application is a continuation-in-part application, claiming priority benefit with regard to all common subject matter to U.S. patent application Ser. No. 13/569,987, entitled “ADJUSTABLE BACKSHELL FOR WIRING HARNESS” and filed Aug. 8, 2012. The earlier-filed identified patent application is hereby incorporated by reference in its entirety.

### BACKGROUND

Backshell devices provide a secure connection between a wiring harness and an associated electrical connector. Backshells not only provide strain relief to prevent damage to the termination points of the wiring harness but may also be designed for coupling with and anchoring a braided sheath encasing the wires in the wiring harness to protect the wiring from the effects of electromagnetic interference (EMI).

The particular design of an electrical or electronic system may require that a wiring harness enter a backshell at a particular angle. For example, some systems require a wiring harness to enter a backshell from a straight orientation, a 45° orientation, or a 90° orientation. To accommodate these different requirements, various configurations of backshells are known, including 0°, 45°, and 90° backshells. Unfortunately, the required orientation of wiring harnesses to their backshells is often not known until the devices are installed, so installers must stock and carry all configurations of the backshells.

Adjustable backshells have been developed in an attempt to resolve the above described problems, but known adjustable backshells are either difficult to use and adjust and/or overly complicated and expensive.

Accordingly, there is a need for an improved adjustable backshell that overcomes the limitations of the prior art.

### SUMMARY

The present invention solves the above-described problems and provides a distinct advance in the art of backshell devices by providing an improved adjustable backshell that can be quickly and easily configured to secure a wiring harness in nearly any orientation.

A backshell constructed in accordance with various embodiments of the invention broadly includes a tubular, open-ended, cable-receiving portion; a tubular, open-ended, connector portion; and a swivel joint interconnecting the cable-receiving portion and connector portion. The cable-receiving portion and connector portion are relatively shiftable my means of the swivel joint so that the cable-receiving portion and connector portion may assume an infinite number of relative positions between a substantially straight and axially aligned position and a 90° position.

An embodiment of the swivel joint may comprise a first circumferentially extending bearing surface carried by a front end of the cable-receiving portion; a second circumferentially extending bearing surface carried by a rear end of the cable connector portion; and structure operable to maintain the first and second bearing surfaces in mating adjacency during relative swiveling movement of the cable-receiving and connector portions.

An embodiment of the structure for maintaining the bearing surfaces together may comprise an annular connection flange carried by the connector portion, and a collar formed in the connector portion and surrounding the connection flange. Mating slots are formed in the annular connection flange and the collar to receive a snap-ring or similar fastener for holding the flange and collar together.

This summary is provided to introduce a selection of concepts in a simplified form that are further described below in the detailed description. This summary is not intended to identify key features or essential features of the claimed subject matter, nor is it intended to be used to limit the scope of the claimed subject matter. Other aspects and advantages of the present invention will be apparent from the following detailed description of the embodiments and the accompanying drawing figures.

### BRIEF DESCRIPTION OF THE DRAWING FIGURES

Embodiments of the present invention are described in detail below with reference to the attached drawing figures, wherein:

FIG. 1 is a perspective view of a backshell constructed in accordance with a first embodiment of the present invention.

FIG. 2 is a side elevational view of the backshell positioned in its straight or aligned orientation.

FIG. 3 is a perspective view of the backshell positioned in its 90° orientation.

FIG. 4 is a vertical sectional view of the backshell positioned in its straight orientation.

FIG. 5 is a vertical sectional view of the backshell positioned in its 90° orientation.

FIG. 6 is a perspective view of the cable receiving portion of the backshell.

FIG. 7 is a perspective view of the connector portion of the backshell with its locking not removed.

FIG. 8 is a perspective view of a backshell in its straight orientation, constructed in accordance with a second embodiment of the present invention.

FIG. 9 is a side elevational view of the second embodiment of the backshell in its straight orientation.

FIG. 10 is a perspective view along the longitudinal axis of the second embodiment of the backshell in its straight orientation.

FIG. 11 is a vertical sectional view taken along line 11-11 of FIG. 9 of the second embodiment of the backshell in its straight orientation.

FIG. 12 is a sectional view taken along line 12-12 of FIG. 10 of the second embodiment of the backshell in its straight orientation illustrating the interior of a swivel joint.

FIG. 13 is a perspective view of the second embodiment of the backshell positioned in its right-angle orientation.

FIG. 14 is an exploded view of the second embodiment of the backshell seen from a first side of the backshell.

FIG. 15 is an exploded view of the second embodiment of the backshell seen from a second side of the backshell.

The drawing figures do not limit the present invention to the specific embodiments disclosed and described herein. The drawings are not necessarily to scale, emphasis instead being placed upon clearly illustrating the principles of the invention.

### DETAILED DESCRIPTION OF THE EMBODIMENTS

The following detailed description of the invention references the accompanying drawings that illustrate specific embodiments in which the invention can be practiced. The embodiments are intended to describe aspects of the invention in sufficient detail to enable those skilled in the art to practice the invention. Other embodiments can be utilized and changes can be made without departing from the scope of the present invention. The following detailed description is, therefore, not to be taken in a limiting sense. The scope of the present invention is defined only by the appended claims, along with the full scope of equivalents to which such claims are entitled.

In this description, references to “one embodiment”, “an embodiment”, or “embodiments” mean that the feature or features being referred to are included in at least one embodiment of the technology. Separate references to “one embodiment”, “an embodiment”, or “embodiments” in this description do not necessarily refer to the same embodiment and are also not mutually exclusive unless so stated and/or except as will be readily apparent to those skilled in the art from the description. For example, a feature, structure, act, etc. described in one embodiment may also be included in other embodiments, but is not necessarily included. Thus, the current technology can include a variety of combinations and/or integrations of the embodiments described herein.

A backshell 10 constructed in accordance with various embodiments of the invention is illustrated in the drawing figures and broadly includes a tubular, open ended, cable-receiving portion 12; a tubular, open ended, connector portion 14; and a swivel joint 16 interconnecting the cable-receiving portion 12 and the connector portion 14. The cable-receiving portion 12 and connector portion 14 are relatively shiftable my means of the swivel joint 16 so that the cable-receiving portion 12 and connector portion 14 may assume an infinite number of relative positions between the substantially straight and axially aligned position of FIGS. 1, 2, and 4 and the 90° position of FIGS. 3 and 5.

Embodiments of the backshell 10 may be used with copper wires, fiber optic cables, or any other conductors. As used herein, the term “wiring harness” includes any number and type of electrical, optical, or other conductors.

The cable-receiving portion 12 of the backshell is best illustrated in FIGS. 4 and 6 and includes a tubular body 18 having a rear section 20 and a forward joint section 22. The rear section 20 includes a sheath termination nipple 24 that is formed by a pair of spaced-apart radially enlarged flanges 26, 28 that define an annular fastener-receiving channel 30 therebetween. The outermost surfaces of the flanges 26, 28 and the channel 30 may be knurled or otherwise roughened to increase their friction. A sheath of a wiring harness (not shown) as well as the wiring harness=s outer jacket may be stretched over the flanges 26, 28 and then compressed and held in the channel 30 by a clamp, clip, spring, or other fastener. A slot 32 is formed in the channel 30 for grounding purposes.

The forward section 22 of the cable-receiving portion 12 includes an obliquely oriented, annular bearing wall 34 provided with a continuous circular groove 36. The forward section also includes a radially outwardly and forwardly extending peripheral collar 38 equipped with an internal slot 40. The outermost surface of the collar 38 may be knurled or otherwise roughened to provide a gripping surface for holding and adjusting the backshell as described below.

The connector portion 14 of the backshell 10 is best illustrated in FIGS. 1, 5, and 7 and includes a tubular body 42 presenting a forward section 44 and a rear joint section 46. The forward section 44 includes a toothed peripheral edge 48 that serves to locate and hold a connector insert as described below and a pair of laterally spaced apart, radially outwardly extending, annular shoulders 50, 52. A threaded coupling nut 54 is rotatably coupled to the forward section of the connector portion by spaced-apart inwardly extending collars 56, 58. The collars 56, 58 are positioned on opposite sides of the shoulder 50 and together define an annular channel 60 in which the shoulder 50 is received.

The forward section 44 also receives and supports a connector insert (not shown) that is configured to mate with a complemental connector on an electrical or electronic device when the coupling nut 54 is threaded over the complemental connector. The connector insert may be a receptacle-type or “female” insert comprising a plurality of receptacles disposed therein or may be a plug-type or “male” insert with a plurality of outwardly extending pins or plugs. The individual wires in the wiring harness enter the rear section 20 of the cable-receiving portion 12 of the backshell and terminate at the rear of the connector insert in a conventional manner.

The rear joint section 46 of the connector portion 14 includes an annular, obliquely oriented connection flange 62 presenting a bearing wall 64 provided with a continuous groove 66. In addition, the outboard surface of the flange 62 has a continuous peripheral slot 68.

As best shown in FIGS. 4 and 5, the forward joint section 22 of the cable-receiving portion 12 and the rear joint section 46 of the connector portion 14 are joined by the swivel joint 16 to present the overall backplate 10. An O-ring 70 is seated within groove 66, and a metallic snap-ring 72 is inserted into slot 68. The forward joint section 22 of the cable-receiving portion 12 is then pressed onto flange 62 of the connector portion 14 such that the collar 38 surrounds the flange 62, and the snap-ring 72 seats into the slots 40 and 68. In this orientation, the bearing walls 34 and 64 are in close, mating adjacency, with the O-ring 70 captively retained between the grooves 36 and 66, and with the snap-ring 72 within slots 40 and 68 serving to maintain the rotary connection between cable-receiving portion 12 and connector portion 14.

In order to adjust the relative positions of the cable-receiving portion 12 and connector portion 14, an installer may simply grasp the portions and exert a relative turning or twisting movement until they are in the desired angular relationship. Advantageously, no tools are required to adjust the angular orientation of the backshell. It will be appreciated that the cable-receiving portion 12 and connector portion 14 may assume any position between that shown in FIG. 1 where the longitudinal axes of the portions are in essentially parallel, offset relation, to the 90° position of FIG. 3. Once positioned in a desired relative orientation, the cable-receiving portion 12 and connector portion 14 may be locked or otherwise held in place by a suitable locking mechanism.

The components of the backshell may be formed by any suitable materials including synthetic resin materials, metals, and allows and may be of any size to accommodate any type and size of wiring harness.

A backshell 100 constructed in accordance with an additional embodiment of the present invention is shown in FIGS. 8-15 and broadly comprises a cable-receiving portion 112, a connector portion 114, and a swivel joint 116. The cable-receiving portion 112 and the connector portion 114 are substantially similar to the cable-receiving portion 12 and the connector portion 14 of the backshell 10 described above. The backshell 100 may further include a first tubular body 118, a rear section 120, a forward joint section 122, a sheath termination nipple 124, a pair of flanges 126, 128, a fastener-receiving channel 130, a first slot 132, a first bearing wall 134, a first groove 136, a first collar 138, a second slot 140, a second tubular body 142, a forward section 144, a rear joint section 146, a peripheral edge 148, a pair of annular shoulders 150, 152, a nut 154, a pair of collars 156, 158, a channel 160, a connection flange 162, a second bearing wall 164, a second groove 166, a third slot 168, an O-ring 170, and a snap ring 172, all of which are substantially similar to the like-named components of the backshell 10 discussed above.

The swivel joint 116 is similar to but not exactly the same as the swivel joint 16. The swivel joint 116 may allow the cable-receiving portion 112 to rotate or swivel with respect to the connector portion 114 to achieve an infinite number of orientations of the backshell 100 between a “straight” orientation, seen in FIGS. 8-10 wherein the longitudinal axes of the cable-receiving portion 112 and the connector portion 114 are in essentially parallel, offset relation, and a “right-angle” orientation, seen in FIG. 13 wherein the longitudinal axes of the two portions 112, 114 are at approximately 90° relative to one another. The swivel joint 16 allows a similar action with the cable-receiving portion 12 and the connector portion 14 of the backshell 10. However, in order to prevent over rotation, which may damage the wiring or cabling retained within the backshell 100, the swivel joint 116 prevents rotation of the cable-receiving portion 112 beyond approximately 180°. Furthermore, the swivel joint 116 may include features which allow the backshell to assume a plurality of easily-selected preset orientations. In addition to some of the components listed above, the swivel joint 116 may further include a race post 174, a race 176, a detent post 178, a post collar 180, and a plurality of detents 182.

The race post 174, as shown in FIGS. 10, 12, and 15, may be generally cylindrical with a sidewall, a first end, and a second end. In an exemplary embodiment, the race post 174 may be positioned on the first bearing wall 134, which is an inner surface of the first collar 138 of the forward joint section 122, such that the second end is attached to the first collar 138 and the first end protrudes outward away from the first collar 138. In other embodiments not shown in the figures, the race post 174 may be positioned on the second bearing wall 164.

The race 176, as shown in exemplary embodiments in FIGS. 10, 11, and 14, may include a channel or recess formed in the surface of the second bearing wall 164 of the rear joint section 146. In other embodiments not shown in the figures, the race 176 may be formed in the surface of the first bearing wall 134. The race post 174 may be retained by and slidable within the race 176. A depth of the race 176 may be equal to or greater than a height of the race post 174. A width of the race 176 may be equal to or greater than a diameter of the race post 174. The race 176 may have a generally arcuate shape. An exemplary race 176 may have semi-circular shape and may extend approximately halfway around, or approximately 180° along, the second bearing wall 164, as best seen in FIGS. 10 and 14. The race 176 may include a first end 184 and an opposing second end 186. The race 176 and the race post 174 may be positioned relative to one another such that, when the backshell is in the straight orientation, the race post 174 is aligned and in contact with the first end 184 of the race 176 and when the backshell is in the right angle orientation, the race post 174 is aligned and in contact with the second end 186 of the race 176.

The detent post 178, as best seen in FIGS. 12, 14, and 15, may be generally cylindrical with a sidewall, a first end, and an opposing second end positioned on a longitudinal axis. In some embodiments, the detent post 178 may have threads on an external surface of the sidewall. Furthermore, the first end may include a single slot, a pair of crossed slots, a hex opening, a torx opening, or the like. The second end may have a convex shape with a rounded or hemispherical surface, a pointed or conical surface, a frustoconical surface, a pyramidal surface, a frusto pyramidal surface, or the like. In some embodiments, the detent post 178 may be a set screw, wherein the first end is configured to receive a tool, such as a screwdriver.

The post collar 180, as shown in FIGS. 8-10 and 12-14, generally has a hollow cylindrical shape with a single sidewall and may be positioned on an outer surface of the first collar 138 of the forward joint section 122. Furthermore, a central axis of the post collar 180 may be aligned with an opening in the first collar 138. In other embodiments not shown in the figures, the post collar 180 may be positioned on an outer surface of the rear joint section 146 and may align with an opening therein. The post collar 180 may include threads on an inner surface of the sidewall. The post collar 180 generally receives the detent post 178 such that the first end of the detent post 178 is accessible above the post collar 180 or through the opening of the post collar 180 and the second end protrudes through the first collar 138. Rotation of the detent post 178 within the post collar 180 adjusts the longitudinal position of the detent post 178 along the axis of the post collar 180.

The detents 182, as shown in FIGS. 10-12 and 14, may include concave impressions formed in the surface of the second bearing wall 164 of the rear joint section 146. In other embodiments not shown in the figures, the detents 182 may be formed in the first bearing wall 134. The detents 182 may have a rounded or hemispherical shape, a pointed or conical shape, a pyramidal shape, or the like. In an exemplary embodiment of the backshell 100, there may be nine detents 182 formed in the second bearing wall 164 with an angular spacing therebetween of approximately 22.5°. Thus, from the first detent 182A to the last detent 182B, the detents 182 may occupy an angular range of approximately 180°. Since both the detents 182 and the race 176 occupy an angular range of approximately 180° on the second bearing wall 164, a portion of the detents 182 may be co-located with a portion of the race 176.

The swivel joint 116 may operate as follows. When the backshell is in the straight orientation, seen in FIGS. 8-10, the race post 174 may be aligned and in contact with the first end 184 of the race 176. And, the first detent 182A may receive and retain the second end of the detent post 178, as shown in FIG. 12. Retention of the detent post 178 in one of the detents 182 provides a resistance to the easy rotation of the cable-receiving portion 112 with respect to the connector portion 114. The resistance may be adjusted by rotating the detent post 178 in the post collar 180. For example, the resistance may be increased by rotating the detent post 178 in a first direction, such as clockwise, while the resistance may be decreased by rotating the detent post 178 in a second, opposing direction, such as counter-clockwise.

A user may adjust the orientation of the backshell 100 by rotating the cable-receiving portion 112 with respect to the connector portion 114. Generally, when the backshell is in the straight orientation, the user may rotate the cable-receiving portion 112 in only a first direction, such as clockwise, because the race post 174 being in contact with the first end 184 of the race 176 prevents rotation of the cable-receiving portion 112 in the opposite (counter-clockwise) direction. While the user rotates the cable-receiving portion 112, the race post 174 may slide within the race 176. The user generally has to apply enough torque to the cable-receiving portion 112 to overcome the resistance provided by the detent post 178 being retained by the first detent 182A. As the user continues to rotate the cable-receiving portion 112, the detent post 178 may become aligned with other detents 182 and may be retained, at least momentarily, therein. If so desired, the user may stop rotation of the cable-receiving portion 112 when the detent post 178 is aligned with any of the intermediate detents 182, or at any other angular position. Once the user rotates the cable-receiving portion 112 approximately 180°, the backshell 100 is in the right-angle orientation, seen in FIG. 13, and the detent post 178 aligns with and is retained by the last detent 182B. In addition, the race post 174 contacts and aligns with the second end 186 of the race 176, thereby prohibiting further rotation in the first direction. When it is desired to return the backshell 100 to the straight orientation, or another angular position, the user may rotate the cable-receiving portion 112 in a second direction, such as counter-clockwise.

Preventing rotation of the cable-receiving portion 112 of the backshell 100 beyond approximately 180° may prevent damage to the wires or cables retained within the backshell 100. The wires may twist, rotate, or bend when the cable-receiving portion 112 is rotated to place the backshell 100 in the right-angle orientation. Allowing the cable-receiving portion to rotate beyond 180° would continue to twist the wires—possibly leading to damage. Since the rotation is limited, when the user wants to return the backshell to the straight orientation, he has to rotate the cable-receiving portion 112 in the opposite direction, which untwists and unbends the wires.

Although the invention has been described with reference to the embodiments illustrated in the attached drawing figures, it is noted that equivalents may be employed and substitutions made herein without departing from the scope of the invention as recited in the claims.

Having thus described various embodiments of the invention, what is claimed as new and desired to be protected by Letters Patent includes the following:

1. An adjustable wiring backshell comprising:
a cable-receiving portion presenting a front section, a rear section, and a first longitudinal axis;
a connector portion presenting a front section, a rear section, and a second longitudinal axis; and
a swivel joint operably coupling the front section of the cable-receiving portion with the rear section of the connector portion and operable to permit selective rotation of the cable-receiving portion relative to the connector portion such that they may assume different orientations with the longitudinal axes thereof at correspondingly different angles, the swivel joint comprising:
a first bearing surface carried by the front section of the cable-receiving portion, the first bearing surface defining a first opening with a first opening radius, and
a second bearing surface carried by the rear section of the connector portion, the second bearing surface defining a second opening with a second opening radius the same size as the first opening radius such that there is a smooth transition from the cable-receiving portion to the connector portion through the first and second openings.

2. The adjustable wiring backshell of claim 1, further comprising an annular connection flange carried by one of the cable-receiving portion and connector portion and including a wall defining one of the first or second bearing surfaces thereof, and a collar formed in the other of the cable-receiving portion and the connector portion and including a wall defining the other of the first or second bearing surfaces, the collar surrounding the connection flange.

3. The adjustable wiring backshell of claim 2, the annular connection flange and the collar including mating slots that receive a snap-ring for holding the annular flange and the collar together.

4. The adjustable wiring backshell of claim 2, the annular connection flange and the collar including mating grooves that receive an O-ring for facilitating the selective relative movement of the cable-receiving portion and the connector portion.

5. The adjustable wiring backshell of claim 1, the cable-receiving portion including a sheath termination nipple for coupling with and terminating a sheath of a wiring harness secured by the backshell.

6. The adjustable wiring backshell of claim 1, the connector portion including a rotatable nut for coupling with an external connector.

7. The adjustable wiring backshell of claim 1, further comprising a locking mechanism for locking the cable-receiving portion and the connector portion in a desired relative position.

8. An adjustable wiring backshell comprising:
a cable-receiving portion presenting a front section, a rear section, and a first longitudinal axis;
a connector portion presenting a front section, a rear section, and a second longitudinal axis; and
a swivel joint operably coupling the front section of the cable-receiving portion with the rear section of the connector portion and operable to permit selective rotation of the cable-receiving portion relative to the connector portion such that they may assume different orientations with the longitudinal axes thereof at correspondingly different angles, the swivel joint comprising:
a race with an arcuate shape including a first end and an opposing second end, and
a race post positioned within the race and slidable therein during a rotation of the cable-receiving portion,
wherein a limit of the rotation is determined by an angle between the first end and the second end of the race.

9. The adjustable wiring backshell of claim 8, wherein the race is positioned on a first bearing surface of the front section of the cable-receiving portion and the race post is positioned on an opposing second bearing surface of the rear section of the connector portion.

10. The adjustable wiring backshell of claim 8, wherein the race has a roughly semicircular shape and the angle between the first end and the second end is approximately 180°.

11. The adjustable wiring backshell of claim 8, wherein the race post is in contact with the first end when the first longitudinal axis is parallel with the second longitudinal axis.

12. The adjustable wiring backshell of claim 8, wherein the race post is in contact with the second end when the first longitudinal axis is at a right angle with the second longitudinal axis.

13. An adjustable wiring backshell comprising:
a cable-receiving portion presenting a front section, a rear section, and a first longitudinal axis;
a connector portion presenting a front section, a rear section, and a second longitudinal axis; and
a swivel joint operably coupling the front section of the cable-receiving portion with the rear section of the connector portion and operable to permit selective rotation of the cable-receiving portion relative to the connector portion such that they may assume different orientations with the longitudinal axes thereof at correspondingly different angles, the swivel joint comprising:
a detent post including a first end configured to receive an adjustment tool and a second end with a convex shape, and
a plurality of detents configured to receive and retain the second end of the detent post,
wherein retention of the detent post in one of the detents provides a resistance to rotation of the cable-receiving portion.

14. The adjustable wiring backshell of claim 13, wherein the detent post is coupled to a first bearing surface of the front section of the cable-receiving portion and the detents are positioned on an opposing second bearing surface of the rear section of the connector portion.

15. The adjustable wiring backshell of claim 13, wherein the swivel joint further comprises a race with an arcuate shape including a first end and an opposing second end, and a race post positioned within the race and slidable therein during a rotation of the cable-receiving portion, wherein a limit of the rotation is determined by an angle between the first end and the second end of the race.

16. The adjustable wiring backshell of claim 15, wherein the race has a roughly semicircular shape and the angle between the first end and the second end is approximately 180°.

17. The adjustable wiring backshell of claim 15, wherein the race post is in contact with the first end when the first longitudinal axis is parallel with the second longitudinal axis.

18. The adjustable wiring backshell of claim 15, wherein the race post is in contact with the second end when the first longitudinal axis is at a right angle with the second longitudinal axis.

19. The adjustable wiring backshell of claim 13, wherein the swivel joint further comprises:
a race with a roughly semicircular shape including a first end and an opposing second end, such that an angle formed between the first end and the second end is approximately 180°, and
a race post positioned within the race and slidable therein during a rotation of the cable-receiving portion,
wherein a limit of the rotation is determined by the angle between the first end and the second end of the race,
the race post is in contact with the first end when the first longitudinal axis is parallel with the second longitudinal axis, and
the race post is in contact with the second end when the first longitudinal axis is at a right angle with the second longitudinal axis.
